(19) United States
(12) Patent Application Publication
(10) Pub. No.: US 2014/0173189 A1
(43) Pub. Date: Jun. 19, 2014

(54) COMPUTING SYSTEM USING NONVOLATILE MEMORY AS MAIN MEMORY AND METHOD FOR MANAGING THE SAME

(71) Applicants: YOUNG-JIN PARK, SEO-GU (KR); HWAJIN JUNG, HWASEONG-SI (KR)

(72) Inventors: YOUNG-JIN PARK, SEO-GU (KR); HWAJIN JUNG, HWASEONG-SI (KR)

(21) Appl. No.: 14/101,379

(22) Filed: Dec. 10, 2013

(30) Foreign Application Priority Data
Dec. 18, 2012 (KR) 10-2012-0148764

(51) Int. Cl. G06F 12/02

(52) U.S. Cl. CPC G06F 12/0246
USPC 711/103

(57) ABSTRACT

A method of managing data of a computing system is provided, where the computing system uses a nonvolatile memory as a main memory. The method includes loading a process into the nonvolatile memory in response to a first run request, freezing the process loaded into the nonvolatile memory in response to an exit request of the process, and activating the process frozen in the nonvolatile memory in response to a second run request of the process. Freezing the process releases control of the process without deleting the process loaded into the nonvolatile memory.

### CROSS-REFERENCE TO RELATED APPLICATIONS

A claim for priority under 35 U.S.C. §119 is made to Korean Patent Application No. 10-2012-0148764 filed Dec. 18, 2012, in the Korean Intellectual Property Office, the entire contents of which are hereby incorporated by reference.

### BACKGROUND

Embodiments of the inventive concept described herein relate to a semiconductor device, and more particularly, relate to a computing system using a nonvolatile memory as a main memory and a data managing method thereof.

Semiconductor memory devices are using semiconductor materials, such as silicon (Si), germanium (Ge), gallium arsenide (GaAs), indium phosphide (InP), and so on. Semiconductor memory devices are classified into volatile memory devices and nonvolatile memory devices.

Volatile memory devices lose stored contents when powered-off. Examples of volatile memory devices include random access memory (RAM), static RAM (SRAM), dynamic RAM (DRAM), synchronous DRAM (SDRAM), and the like. The nonvolatile memory devices generally retain stored contents, even during power-off. Examples of nonvolatile memory devices include read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), and so on.

In a conventional computing device, volatile memories, such as DRAM and SRAM, may be used as a working memory, and nonvolatile memories, such as HDD and flash memory, may be used as storage. Data stored in volatile memory may be lost at power-off. When power is resumed, the computing device must again store data in the volatile memory. Techniques for applying nonvolatile random access memories (e.g., PRAM, MRAM, FRAM, RRAM, etc.) to a working memory of the computing device are currently being researched.

### SUMMARY

One aspect of the inventive concept is directed to a method of managing data of a computing system, where the computing system uses a nonvolatile memory as a main memory. The method includes loading a process into the nonvolatile memory in response to a first run request, freezing the process loaded into the nonvolatile memory in response to an exit request of the process, and activating the process frozen in the nonvolatile memory in response to a second run request of the process. Freezing the process releases control of the process without deleting the process loaded into the nonvolatile memory.

Freezing the process may retain a memory area of the nonvolatile memory corresponding to the process without releasing.

The method may further include adding an address allocated to the process to a run process table in response to the first run request.

The method may further include moving the address of the process registered in the run process table to an exit process table in response to the exit request. Moving the address may include selecting a priority of the process referring to a priority table, and moving the address of the process to the exit process table according to the selected priority.

The priority may be selected according to information on a time when the process is most recently used or a run frequency of the process. The priority the process may increase in proportion to an increase in a run frequency of the process. The priority of the process may increase in proportion to an increase in an exit time of the particular process. Each of the run process table and the exit process table may be configured to store a run frequency of each process.

Moving the address of the process to the exit process table according to the selected priority may include comparing priorities of processes previously registered in the exit process table with the selected priority.

When a release request is generated, memory areas of processes registered in the exit process table may be released in an order from a process having a lower priority to a process having a higher priority. An address of a process corresponding to a released memory area may be removed from the exit process table.

The method may further include releasing a memory area corresponding to a process frozen in the nonvolatile memory when free space of the nonvolatile memory is not sufficient for loading the process.

The memory areas corresponding to processes loaded into the nonvolatile memory or frozen processes may not be released even at power-on or power-off.

Another aspect of the inventive concept is directed to a computing system, including a nonvolatile storage, a nonvolatile main memory, and a processor. The processor is configured to load a process into the nonvolatile main memory from the nonvolatile storage in response to a first run request, to freeze the process loaded into the nonvolatile main memory in response to an exit request of the process, and to activate the process frozen in the nonvolatile main memory in response to a second run request of the process. Freezing the process releases control of the process without deleting of the process loaded into the nonvolatile main memory. The processor is further configured to skip an operation of loading the process into the nonvolatile main memory from the nonvolatile storage in response to the second run request.

Another aspect of the inventive concept is directed to a processor in a computing system including a main memory. The processor includes a core configured to control processes of the computing system, a main memory unit configured to manage the main memory under control of the core, and a process manager configured to manage information on processes run and exited by the processor. The process manager includes a run process table for storing information on processes in response to run requests and an exit process table for storing information on processes transferred from the run process table in response to exit requests. The process manager determines whether a process of a run request, received by the core, is cached using the exit process table. When the process manager determines that the process is cached, one of the core and the main memory unit activates a memory area in which the process is stored, and moves information regarding the process from the exit process table to the run process table of the process manager. When the process manager determines that the process is not cached, one of the core and the main memory unit allocates a memory area of the main memory for the process, and adds information regarding the process to the run process table of the process manager.

With embodiments of the inventive concept, a terminated or exited process may be maintained in a nonvolatile main memory without deletion. When a corresponding process is again run, the process stored at the nonvolatile main memory may be activated. Accordingly, it is possible to improve operating speed and user convenience.

### BRIEF DESCRIPTION OF THE FIGURES

The above and other objects and features will become apparent from the following description with reference to the following figures, in which like reference numerals refer to like parts throughout the various figures unless otherwise specified:

FIG. 1 is a block diagram schematically illustrating a computing system, according to an embodiment of the inventive concept.

FIG. 2 is a block diagram schematically illustrating a processor, according to an embodiment of the inventive concept.

FIG. 3 is a block diagram schematically illustrating a process manager, according to an embodiment of the inventive concept.

FIG. 4 is a flow chart schematically illustrating a data managing method of a computing system, according to an embodiment of the inventive concept.

FIG. 5 is a detailed flow chart of an operation of loading a process into a main memory, according to an embodiment of the inventive concept.

FIG. 6 is a detailed flow chart of an operation of freezing a process, according to an embodiment of the inventive concept.

FIG. 7 is a detailed flow chart of an operation of activating a frozen process, according to an embodiment of the inventive concept.

FIG. 8 is a flow chart schematically illustrating a method where a memory area corresponding to a frozen process is released, according to an embodiment of the inventive concept.

FIGS. 9A to 9D are diagrams schematically illustrating a data managing method of a computing system, according to an embodiment of the inventive concept.

FIGS. 10A to 10D are diagrams schematically illustrating a data managing method of a computing system, according to another embodiment of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the terms “exemplary” and “exemplarily” are intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

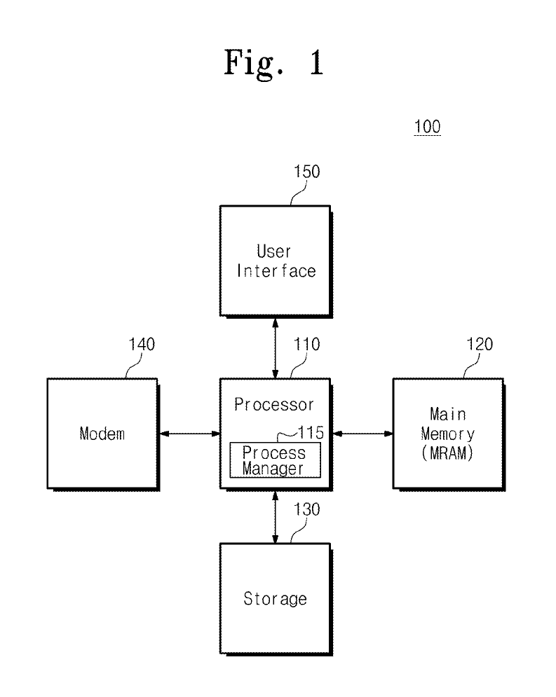

FIG. 1 is a block diagram schematically illustrating a computing system 100, according to an embodiment of the inventive concept. Referring to FIG. 1, the computing system 100 includes a processor 110, a main memory 120, storage 130, a modem 140, and a user interface 150.

The processor 110 controls overall operation of the computing system 100, and performs logical operations. The processor 110 may run various processes, such as word processors, spread sheets, browsers, games, internet messengers, and so on. The processor 110 may be formed of a system-on-chip (SoC). The processor 110 may include a general purpose processor or an application processor. The processor 110 may also include a process manager 115. The process manager 115 is configured to manage information on various processes run and/or terminated by the processor 110.

The main memory 120 communicates with the processor 110. The main memory 120 may be a working memory of the processor 110 and/or the computing system 100. The main memory 120 may include volatile memory, such as static RAM, dynamic RAM, synchronous DRAM, or the like, and/or nonvolatile memory, such as flash memory, phase-change RAM (PRAM), magnetic RAM (MRAM), resistive RAM (RRAM), ferroelectric RAM (FRAM), or the like.

The storage 130 stores data that the computing system 100 retains for a long time. The storage 130 may include a hard disk drive or nonvolatile memory, such as flash memory, phase-change RAM (PRAM), magnetic RAM (MRAM), resistive RAM (RRAM), ferroelectric RAM (FRAM), or the like.

Exemplarily, the main memory 120 and the storage 130 may be formed of the same type of nonvolatile memory. In this case, the main memory 120 and the storage 130 may be integrated in a semiconductor integrated circuit.

The modem 140 is configured to communicate with external devices under control of the processor 110. For example, the modem 140 may communicate with an external device in a wired or wireless manner. The modem 140 may communicate using one or more wireless communications techniques, such as Long Term Evolution (LTE), WiMax, Global System for Mobile communication (GSM), Code Division Multiple Access (CDMA), Bluetooth, Near Field Communication (NFC), WiFi, Radio Frequency Identification (RFID, and so on, and/or wired communications manners such as Universal Serial Bus (USB), Serial Advance Technology Attachment (SATA), Small Computer Small Interface (SCSI), Firewire, Peripheral Component Interconnection (PCI), and so on.

The user interface 150 is configured to communicate with a user under control of the processor 110. For example, the user interface 150 may include user input interfaces, such as a keyboard, a keypad, a button, a touch panel, a touch screen, a touch pad, a touch ball, a camera, a microphone, a gyroscope sensor, a vibration sensor, and so on. The user interface 150 may further include user output interfaces, such as an LCD, an Organic Light Emitting Diode (OLED) display device, an Active Matrix OLED (AMOLED) display device, an light emitting diode (LED), a speaker, a motor, and so on.

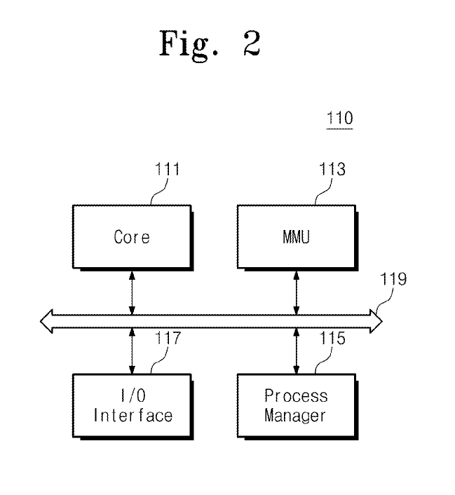

FIG. 2 is a block diagram schematically illustrating processor 110, according to an embodiment of the inventive concept. Referring to FIGS. 1 and 2, the processor 110 includes a core 111, a memory management unit (MMU) 113, a process manager 115, an input/output (I/O) interface 117, and an internal bus 119.

The core 111 is a key component of the processor 110. The core 111 may run control and logic operations, as well as run various processes.

The memory management unit 113 manages the main memory 120 under control of the core 111. The memory management unit 113 may translate a logical address from the core 111 into a physical address of the main memory 120. Exemplarily, in the event that part of the storage 130 is used as a virtual memory, the memory management unit 113 may manage that part of the storage 130.

The process manager 115 manages information on processes run by the processor 110 (run processes) and/or processes that have been terminated (exit processes). The process manager 115 may operate under control of the core 111 and/or the memory management unit 113.

The input/output interface 117 intermediates between the processor 110 and an external component (e.g., main memory 120, storage 130, modem 140, and/or user interface 150) of the processor 110. The internal bus 119 provides a channel among the various internal components (e.g., the core 111, the memory management unit 113, the process manager 115, and the input/output interface 117) of the processor 110.

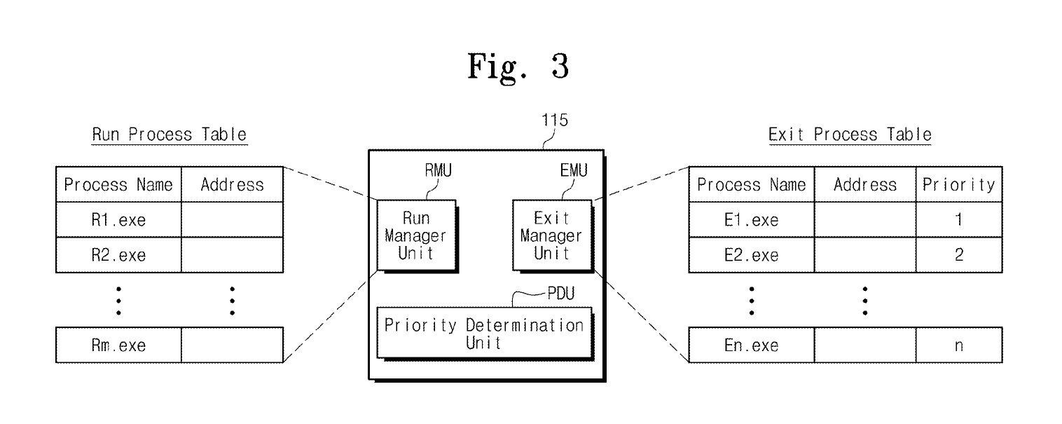

FIG. 3 is a block diagram schematically illustrating process manager 115, according to an embodiment of the inventive concept. Referring to FIG. 3, the process manager 115 includes a run manager unit RMU, an exit manager unit EMU, and a priority determination unit PDU.

The run manager unit RMU is configured to manage a run process table. The run process table includes information on processes being run by the processor 110. For example, the run process table may include a process name field and an address field. The process name field stores as records names of processes being run by the processor 110. The address field stores as records addresses allocated to the processes run by the processor 110. For example, the address field may store logical or physical addresses allocated to processes.

The exit manager unit EMU is configured to manage an exit process table. The exit process table includes information on processes run by the processor 110 and then terminated (exited). For example, the exit process table may include a process name field, an address field, and a priority field. The process name field stores as records names of terminated processes, which were run by the processor 110 and then exited. The address field stores as records addresses allocated to processes, which were run by the processor 110 and then exited. For example, the address field may store logical or physical addresses allocated to processes. The priority field stores as records priorities corresponding to processes, which were run by the processor 110 and then exited. For example, the priority field may record a priority based on probability that a corresponding exit process registered in the exit process table will be run again (or, accessed). A process having high priority means that the probability is relatively high that the process will be run again, and a process having a low priority means that the probability is relatively low that the process will be run again.

For example, whenever a process is run by the processor 110, information on the run process is registered in the run process table, and when the process is terminated, information on the terminated process is recorded in the exit process table. When a process is run for which information has not been stored in the process manager 115, the information of the run process is newly registered in the run process table. When a process is run for which information has been stored in the process manager 115, the information of the run process is shifted from the exit process table to the run process table.

Also, for example, when a process run by the processor 110 is terminated, the corresponding information is transferred from the run process table to the exit process table. When a process registered in the exit process table is run again by the processor 110, the corresponding information is transferred from the exit process table to the run process table. A memory area corresponding to a process registered in the exit process table may be released, as discussed below, in which case the corresponding information is removed from the exit process table. Processes registered in the exit process table may be aligned in a queue shape according to priority.

The run manager unit RMU and the exit manager unit EMU may retain the run process table and the exit process table, respectively, regardless of power-on or power-off condition of the computing system 100. For example, the run manager unit RMU and the exit manager unit EMU may include nonvolatile memories for storing the run process table and the exit process table, respectively. The run manager unit RMU and the exit manager unit EMU may include volatile memories to store the run process table and the exit process table, respectively, and the run process table and the exit process table may be backed up to the main memory 120 periodically or at power-on/off, for example.

The priority determination unit PDU determines priorities of processes registered in the exit process table. For example, the priority determination unit PDU may store one or more rules for determining priorities of the processes registered in the exit process table. For example, the priority determination unit PDU may determine the priorities of the processes based on process exit times or based on process execution frequency. Exemplarily, a higher priority may be allocated to a more recently exited process, or a higher priority may be allocated to a more frequently run process.

Exemplarily, in the event that the priority determination unit PDU determines the priority of a process based on execution frequency, each of the run process table and the exit process table may further include an execution frequency field (not shown). The execution frequency field may include information on exit and re-execution frequency after a process is run, and the run process table is registered. For example, execution frequency may increase whenever process information is transferred from the exit process table to the run process table.

Exemplarily, when execution of a particular process is exited, the priority determination unit PDU may compare an execution frequency of the terminated process with execution frequencies of processes registered in the exit process table. The priority determination unit PDU may detect a process having the same execution frequency as that of a terminated process, from the exit process table. The priority determination unit PDU may determine a priority of the terminated process based on the terminated process and the detected processes. For example, the priority determination unit PDU may allocate a priority to the terminated process higher than priorities of processes exited prior to the terminated process. As a priority is allocated to the terminated process, a priority of a process having an existing priority and priorities of processes each having a lower priority may be pushed step by step. That is, the terminated process may be inserted at a location of the exit process table corresponding to the selected priority.

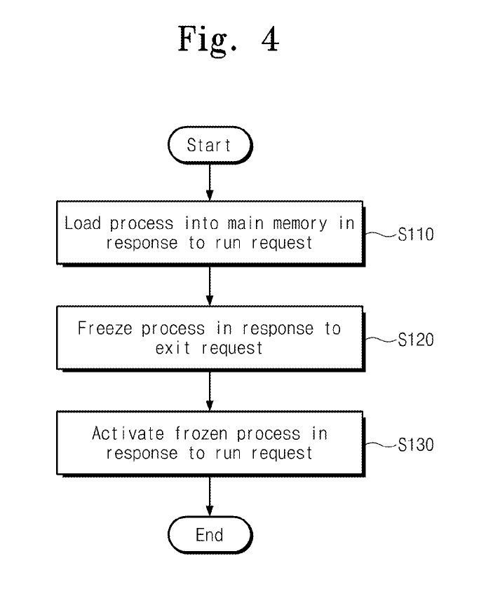

FIG. 4 is a flow chart schematically illustrating a method of managing data of the computing system 100, according to an embodiment of the inventive concept. Referring to FIGS. 1 to 4, in operation S110, a process is loaded into main memory 120 in response to a run request. For example, the run request may be generated by a user of the computing system 100. In response to the run request, the processor 110 reads a requested process from storage 130 to load it into the main memory 120. When the requested process is not a process registered in the process manager 115, the processor 110 loads the requested process in the main memory 120. Information corresponding to the loaded process is registered in the run process table.

In operation S120, a process is exited and frozen in response to an exit request. For example, the exit request may be generated by a user of the computing system 100. In response to the exit request, the processor 110 freezes the exited process. Data of the frozen process is retained in the main memory 120 without deletion. Information regarding the frozen process is transferred from the run process table to the exit process table.

In operation S130, the frozen process is activated in response to another run request. The run request may be generated by a user of the computing system 100. That is, when a run requested process is a process registered in the exit process table, the processor 110 activates a corresponding frozen process in response to the run request. For example, the processor 110 may run a process in response to the run request by identifying the process frozen in the main memory 120, and therefore not loading the run requested process into the main memory 120 from the storage 130. Information regard the activated process may be transferred from the exit process table to the run process table.

In exemplary embodiments, the memory area of the main memory 120, in which a process exited after running is stored, is not released. The exited process may be separately managed using the exit process table. When a run request on an exited process is again generated, a process frozen in the main memory 120 is activated according to information registered in the exit process table, instead of loading the requested process on the main memory 120 from the storage 130. Since a process loading operation is not required, the operating speed of the computing system 100 is improved.

Also, while a process loaded from the storage 130 may only include initial data, a process frozen in the main memory 120 may further include contents which the user provides. Since contents provided by the user are restored by running an exited process, user convenience of the computing system 100 is improved.

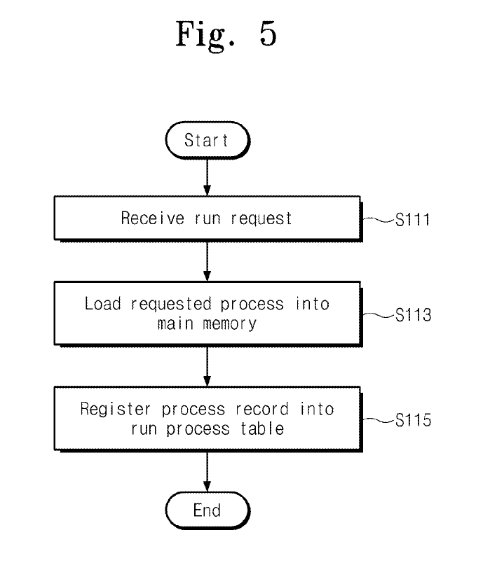

FIG. 5 is a flow chart of an operation of loading a process into a main memory. Referring to FIGS. 1, 3, and 5, a run request is received in operation S111. The processor 110 may receive the run request regarding a particular process.

In operation S113, the requested process is loaded into the main memory 120. The processor 110 may read the requested process from storage 130 to load it into the main memory 120. In operation S115, a process record is registered in the run process table. The processor 110 may register information of a process loaded into the main memory 120 as a record of the run process table.

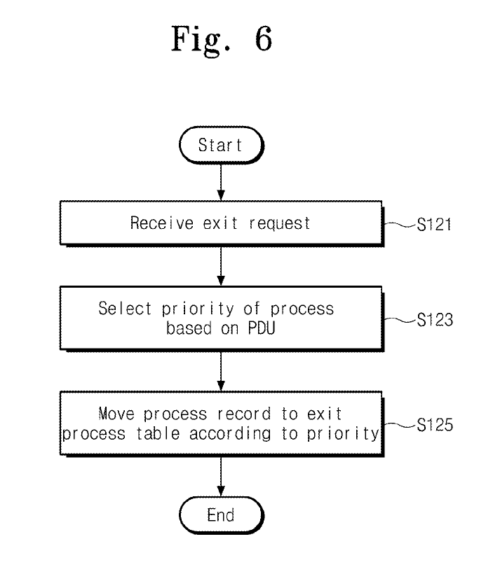

FIG. 6 is a flow chart of an operation of freezing a process. Referring to FIGS. 1, 3, and 6, an exit request is received in operation S121. The processor 110 receives an exit request with regard to a particular process being run.

In operation S123, a priority of the exit requested process may be determined, at least in part, by the priority determination unit PDU. For example, a core 111, a memory management unit 113, and/or the priority determination unit PDU may determine the priority of an exit requested process, based on a priority determination rule stored in the priority determination unit PDU. The priority may be determined according to a run frequency or an exit time of the exit requested process, for example. The priority may be determined according to comparison results between the exit requested process and processes registered in the exit process table.

In operation S125, a process record corresponding to the exited process is moved into an exit process record according to the priority. For example, the processor 110 may move a record registered in the run process table to the exit process table. Afterwards, the processor 110 may release control of the frozen process. However, a memory area of the main memory 120 corresponding to the frozen process is not released. The frozen process can therefore be retained in the main memory 120 without it being accessed.

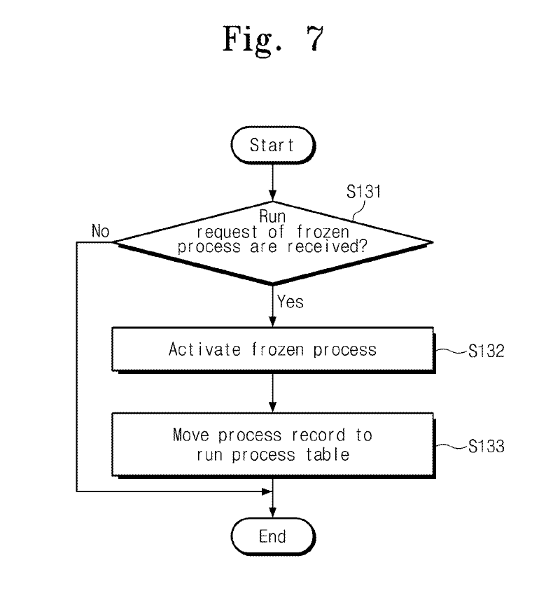

FIG. 7 is a flow chart of an operation of activating a frozen process. Referring to FIGS. 1, 3, and 7, it is determined in operation S131 whether a run request for a frozen process is received. That is, the processor 110 receives a run request of a particular process, and determines whether the particular process is a frozen process based on the exit process table. When the particular process is not a frozen process, as illustrated in FIG. 5, loading of the process is performed.

When the particular process is a frozen process, the frozen process is activated in operation S132. The processor 110 may determine an address of the frozen process based on the exit process table. The processor 110 may acquire control of the frozen process according to the determined address. In operation S133, a process record corresponding to the frozen process is moved to the run process table. That is, the processor 110 may move the record of a particular process from the exit process table to the run process table.

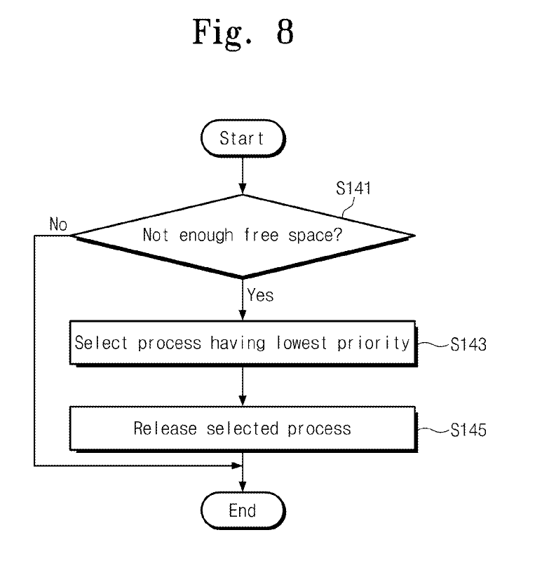

FIG. 8 is a flow chart schematically illustrating a method in which a memory area corresponding to a frozen process is released. Referring to FIGS. 1, 3, and 8, it is determined in operation S141 whether there is sufficient free space of the main memory 120, e.g., to load a process. When the free space is sufficient, a frozen process in the main memory 120 is not released. When the free space is not sufficient, a frozen process may be released.

In operation S143, a process having the lowest priority is selected for release. The processor 110 may select a process having the lowest priority from among processes registered in the exit process table. In operation S145, the selected process is released. The processor 110 may release a memory area allocated to the selected process.

Exemplarily, the release of a frozen process may be performed when a run request of a new process is received. When a run request of a new process is received, a memory area of the main memory 120 may be allocated to the new process. At this time, when there is not enough free space in the main memory 120, a memory area of a frozen process is released. A memory area including all or a part of the released memory area is allocated to the new process.

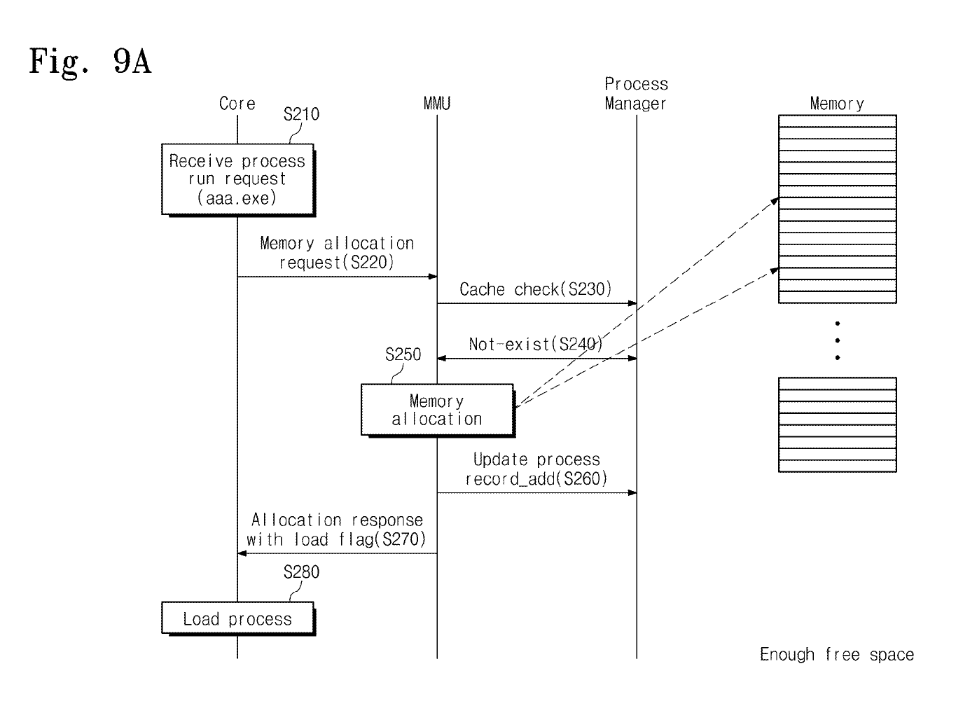

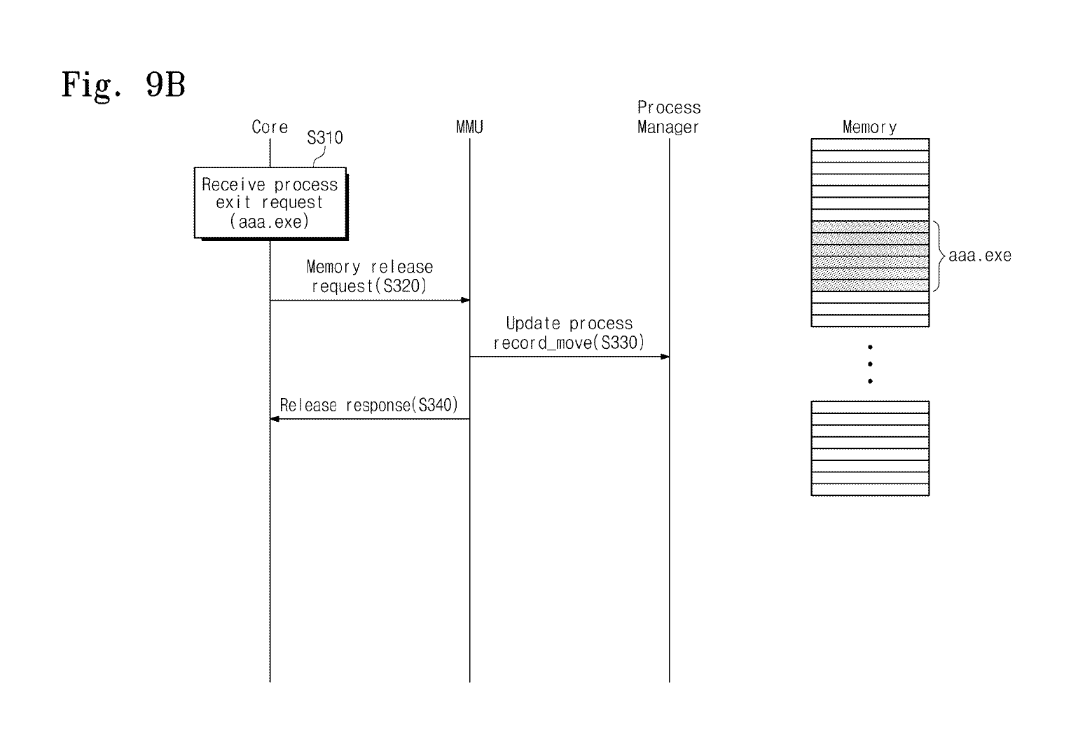

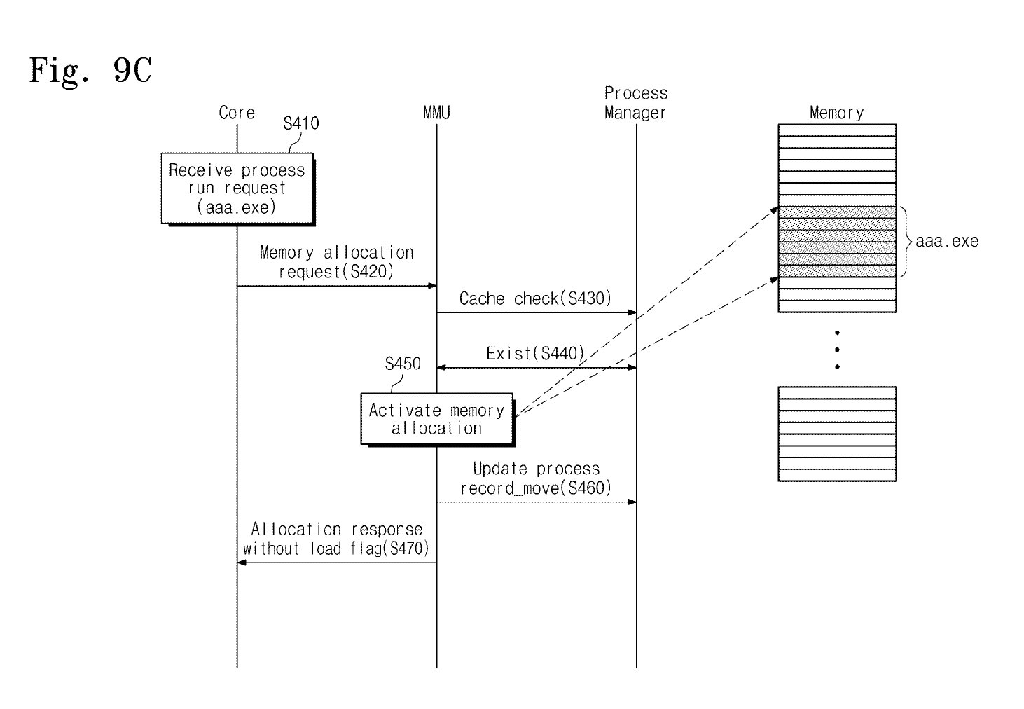

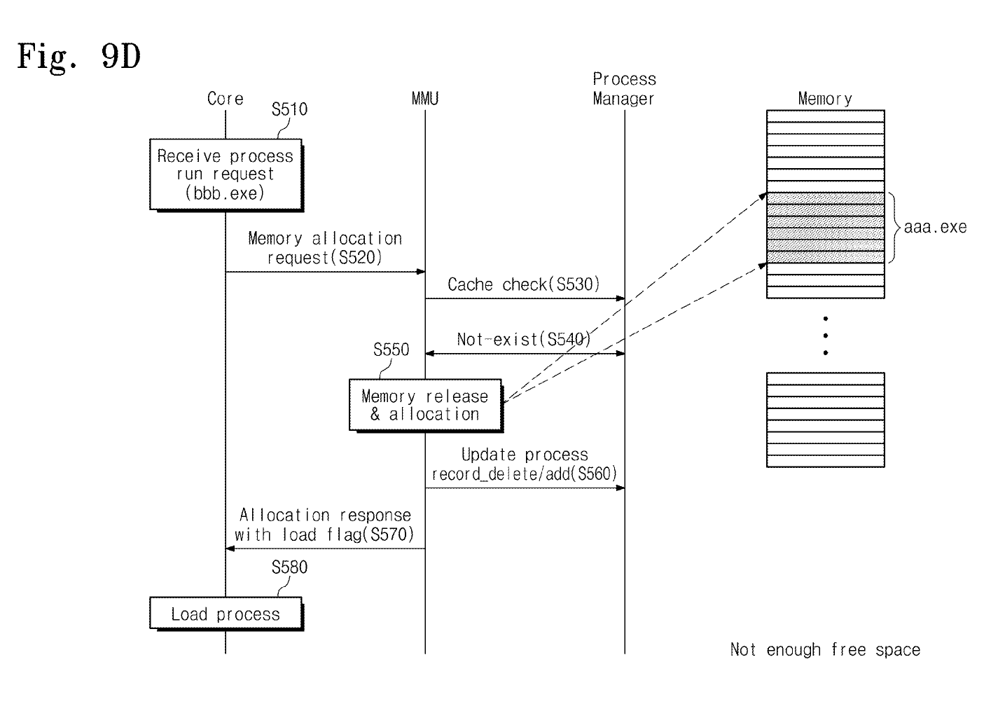

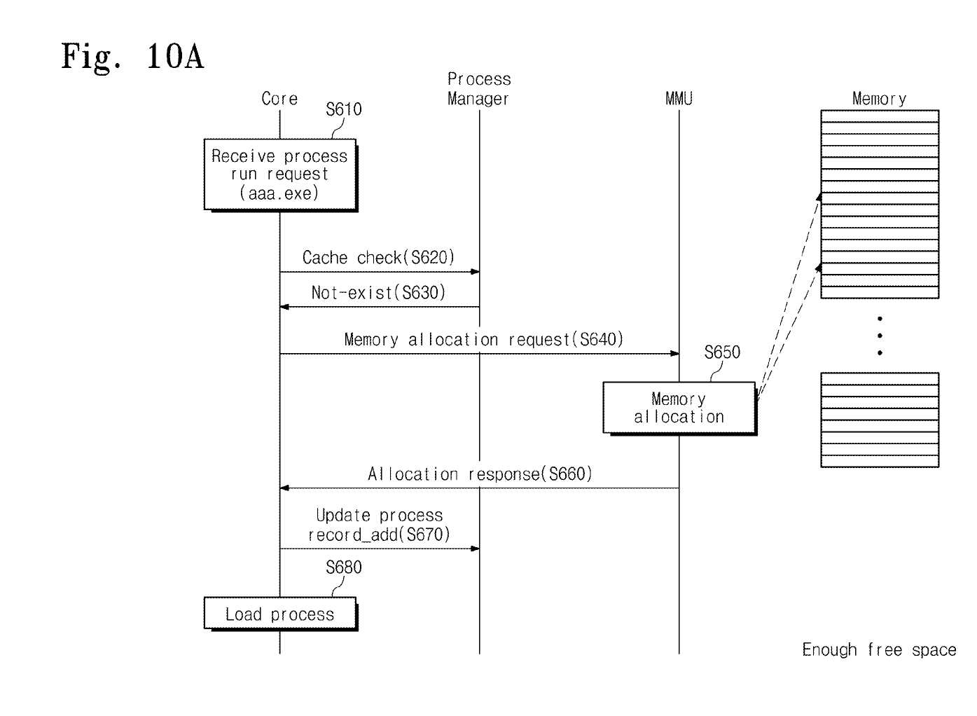

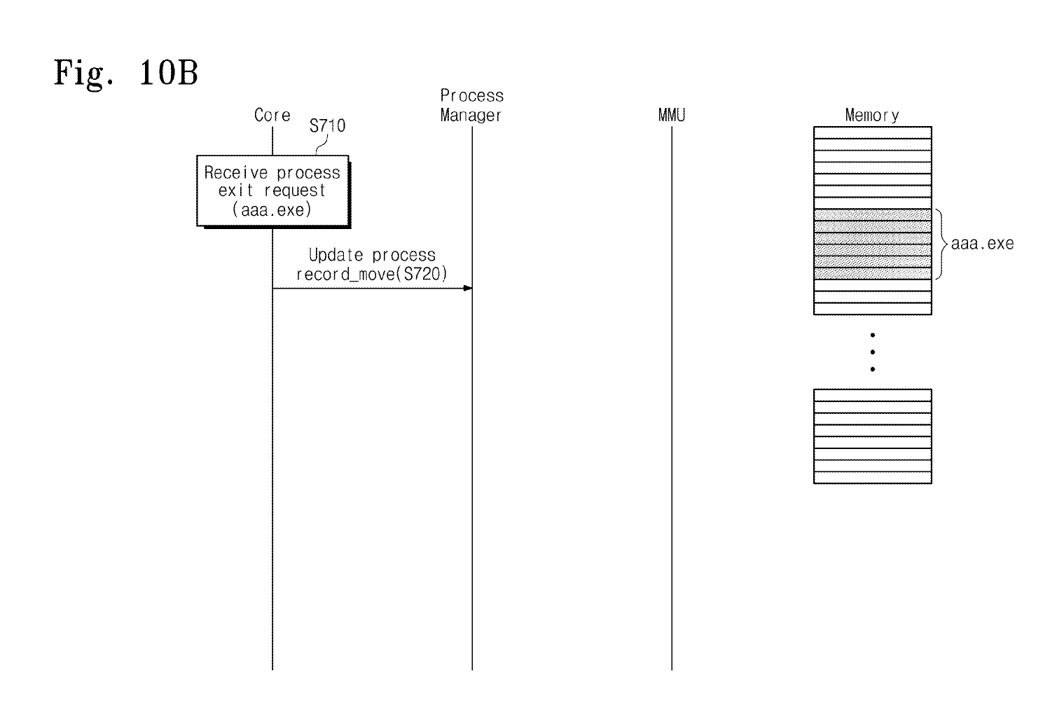

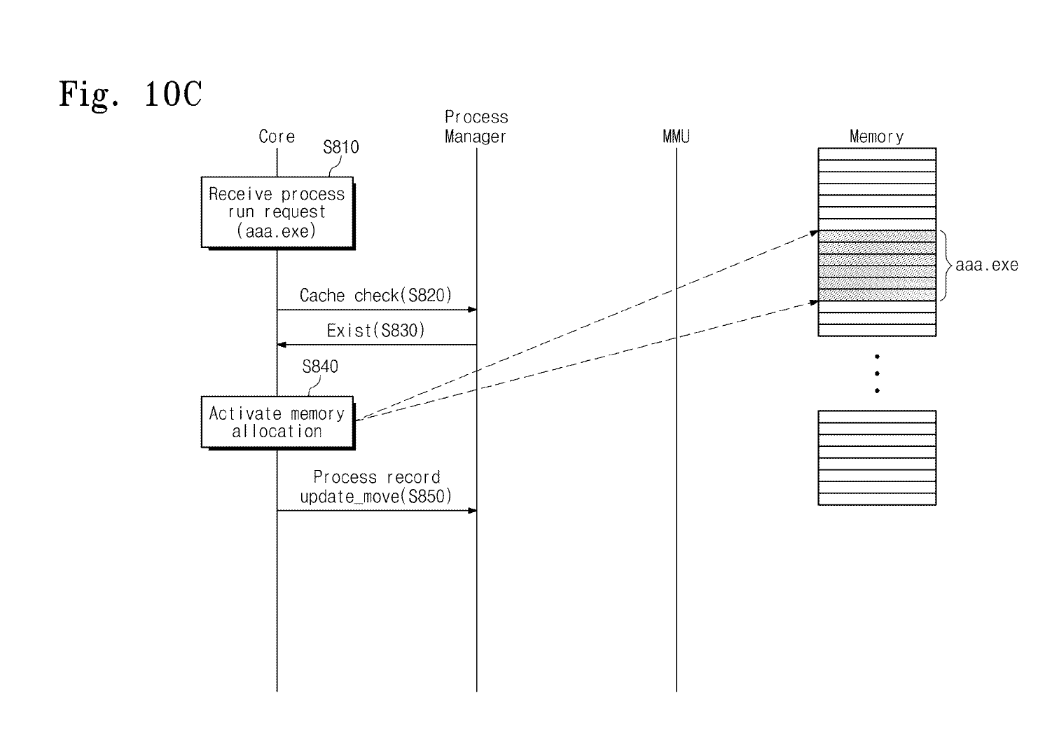

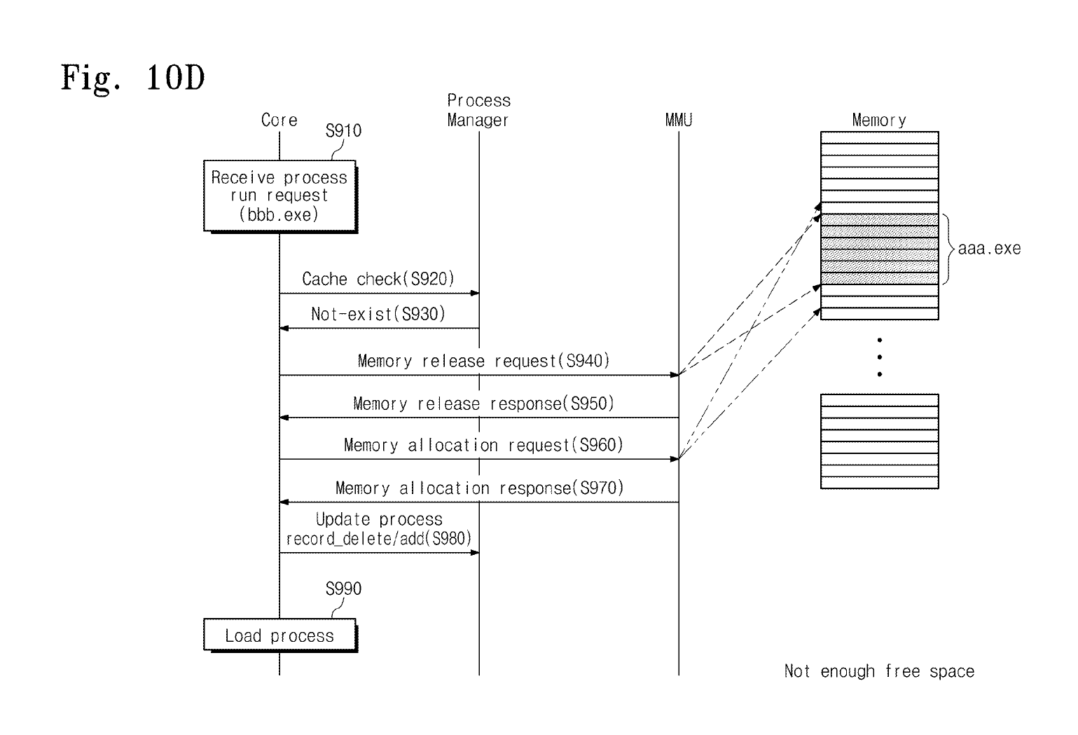

FIGS. 9A to 9D are diagrams schematically illustrating a data managing method of the computing system 100, according to an embodiment of the inventive concept. FIGS. 10A to 10D are diagrams schematically illustrating a data managing method of the computing system 100, according to another embodiment of the inventive concept. In FIGS. 9A to 9D and 10A to 10D, interaction among internal components of the computing system 100 are illustrated.

FIG. 9A illustrates an example in which a new process not registered in the process manager 115 is run. Referring to FIGS. 1 to 3 and 9A, the core 111 of the processor 110 receives a process run request in operation S210. For example, the core 111 may receive a run request for process “aaa.exe”.

In operation S220, the core 111 sends a memory allocation request to the memory management unit 113 of the processor 110. For example, the core 111 may allocate a logical address where “aaa.exe” is to be stored, and may send the allocated logical address and the memory allocation request to the memory management unit 113.

In operation S230, the memory management unit 113 performs a cache check in response to the memory allocation request. The cache check is an operation of checking whether a process corresponding to the memory allocation request is cached in the process manager 115 of the processor 110. For example, the memory management unit 113 may check whether a process corresponding to the memory allocation request is registered in an exit process table of the process manager 115.

Since it is assumed for purposes of discussing FIG. 9A that the requested run process is a new process not registered in the process manager 115, it may be further assumed that a process corresponding to the memory allocation request is not yet registered in the process manager 115. Thus, in operation S240, the memory management unit 113 determines that the process corresponding to the memory allocation request is not registered (e.g., does not exist) in the process manager 115.

Exemplarily, in operations S230 and 240, the memory management unit 113 may directly access process tables managed by the process manager 115 to perform the cache check. The memory management unit 113 may send a check request to the process manager 115, and may perform the cache check by receiving a check result from the process manager 115.

Since the process corresponding to the memory allocation request is not registered in the process manager 115, in operation S250, the memory management unit 113 performs memory allocation. The memory management unit 113 may allocate a memory area, corresponding to a size of the run requested process, from among free storage areas of the main memory 120.

In operation S260, the memory management unit 113 updates a process record of the process manager 115. For example, the memory management unit 113 may add information of the run requested process to a record of the run process table. Exemplarily, the memory management unit 113 may directly access and update the run process table managed by the process manager 115. The memory management unit 113 may update the run process table by sending an update request to the process manager 115.

In operation S270, the memory management unit 113 sends an allocation response to the core 111. The allocation response is sent together with a load flag, which is a signal indicating that loading of a process is required.

In operation S280, the core 111 loads the process into a memory area allocated by the memory management unit 113. The core 111 reads the process from the storage 130 to load it into the allocated memory area.

FIG. 9B illustrates an example in which a process run by the processor 110 is exited. It is assumed that the operation of FIG. 9B is performed after the operation of FIG. 9A is ended. Referring to FIGS. 1 to 3 and 9B, the core 111 receives a process exit request in operation S310. For example, the core 111 may receive an exit request for exiting the process “aaa.exe”.

In operation S320, the core 111 sends a memory release request to the memory management unit 113. The core 111 may send a memory release request of the memory area allocated to the exit requested process to the memory management unit 113. The core 111 may release control of the exit requested process before or after the memory release request is transferred, or at the same time the memory release request is transferred.

In operation S330, the memory management unit 113 updates a process record of the process manager 115 without releasing of the memory area allocated to the exit requested process. For example, the memory management unit 113 may move a record of the exit requested process to the exit process table from the run process table. Exemplarily, the memory management unit 113 may directly access and update the run process table managed by the process manager 115. The memory management unit 113 may update the process table by sending an update request to the process manager 115.

In operation S340, the memory management unit 113 sends a release response to the core 111. The memory management unit 113 may send information, indicating that a release of the memory area corresponding to the release request is completed, to the core 111.

FIG. 9C illustrates an example in which a frozen process is activated. It is assumed that the operation of FIG. 9C is performed after the operation of FIG. 9B is ended. Referring to FIGS. 1 to 3 and 9C, the core 111 receives a process run request in operation S410. For example, the core 111 may receive a run request for the process “aaa.exe”.

The core 111 sends a memory allocation request to the memory management unit 113 (S420), and the memory management unit 113 performs a cache check (S430). Operations S420 and S430 may be performed substantially the same as operations S220 and S230 discussed above with reference to FIG. 9A.

In operation S440, the run requested process is determined to be registered (e.g., exists) in the process manager 115. Thus, in operation S450, instead of allocating a free storage area of the main memory 120, the memory management unit 113 activates the memory area in which the frozen process is stored, according to an address registered in the process manager 115. For example, the memory management unit 113 may treat an area, in which the frozen process is stored, to be allocated, without deleting of the memory area in which the frozen process is stored.

In operation S460, the memory management unit 113 updates a process record of the process manager 115. For example, a process record registered in the exit process table may be moved to the run process table.

In operation S470, the memory management unit 113 sends an allocation response to the core 111. The allocation response is sent without a load flag. For example, the memory management unit 113 may send a signal, indicating that loading of a process is not required, together with the allocation response. The core 111 may then activate control of the frozen process without execution of loading of a process.

FIG. 9D illustrates an example in which a memory area corresponding to a frozen process is released. It is assumed that the operation of FIG. 9D is performed after the operation of FIG. 9C is ended. Referring to FIGS. 1 to 3 and 9D, the core 111 receives a process run request in operation S510. For example, the core 111 may receive a run request for process “bbb.exe”.

The core 111 sends a memory allocation request to the memory management unit 113 (S520), and the memory management unit 113 performs a cache check (S530). Operations S520 and S530 may be performed substantially the same as operations S220 and S230 discussed above with reference to FIG. 9A.

In operation S540, the memory management unit 113 determines that the run requested process corresponding to the memory allocation request is not registered (e.g., does not exist) in the process manager 115.

In operation S550, the memory management unit 113 may perform memory release and allocation. That is, when the main memory 120 has sufficient free space to load the run requested process, memory allocation is performed in substantially the same manner as described with reference to FIG. 9A, for example. However, when the main memory 120 does not have sufficient free space to load the run requested process, the memory management unit 113 performs memory release and allocation.

The memory management unit 113 may release a memory area corresponding to a frozen process. For example, the memory management unit 113 may release a process having the lowest priority from among frozen processes. Afterwards, the memory management unit 113 may allocate a memory area including all or a part of the released memory area. The memory management unit 113 may allocate a memory area corresponding to the size of the run requested process.

In operation S560, the memory management unit 113 updates a process record of the process manager 115. For example, a record of the frozen process corresponding to the released memory area may be deleted from the exit process table. A record of the process corresponding to the allocated memory area may be added to the run process table.

In operation S570, the memory management unit 113 sends an allocation response to the core 111. The allocation response is sent together with a load flag, indicating that loading of a process is required. In operation S580, the core 111 loads the run requested process into the allocated memory area of the main memory 120.

As described with reference to FIGS. 9A to 9D, the process manager 115 may be accessed by the memory management unit 113. The memory management unit 113 may perform process freeze, activation, and release operations using process tables of the process manager 115.

FIG. 10A illustrates an example in which a new process not registered in a process manager 115 is run. Referring to FIGS. 1 to 3 and 10A, the core 111 receives a process run request in operation S610. For example, the core 111 may receive a run request for process “aaa.exe”.

In operation S620, the core 111 performs a cache check in response to the process run request. The cache check is an operation of checking whether a process corresponding to the process run request is cached at the process manager 115 of the processor 110. For example, the core 111 may check whether a process corresponding to the process run request is registered in the exit process table of the process manager 115.

Since it is assumed that a new process not registered in the process manager 115 is being run, it is further assumed that the process corresponding to the process run request is not registered in the process manager 115. Thus, in operation S630, the core 111 determines that the process corresponding to the process run request is not registered (e.g., does not exist) in the process manager 115.

Exemplarily, in operations S630 and S640, the core 111 may directly access process tables managed by the process manager 115 to perform the cache check. The core 111 may send a check request to the process manager 115, and may perform the cache check by receiving a check result from the process manager 115.

In operation S640, the core 111 sends a memory allocation request to the memory management unit 113. For example, the core 111 may allocate a logical address at which “aaa.exe” is to be stored, and may send the allocated logical address and the memory allocation request to the memory management unit 113.

In operation S650, the memory management unit 113 performs memory allocation. The memory management unit 113 may allocate a memory area, corresponding to a size of the run requested process, from among free storage areas of the main memory 120. In operation S660, the memory management unit 113 sends an allocation response to the core 111.

In operation S670, the core 111 updates a process record of the process manager 115. For example, the core 111 may add information of the run requested process to a record of the run process table. Exemplarily, the core 111 may directly access and update the run process table managed by the process manager 115. The core 111 may update the run process table by sending an update request to the process manager 115.

In operation S680, the core 111 loads a process into the memory area allocated by the memory management unit 113. The core 111 reads the process from the storage 130 to load it into the allocated memory area.

FIG. 10B illustrates an example in which a process run by the processor 110 is exited. It is assumed that the operation of FIG. 10B is performed after the operation of FIG. 10A is ended. Referring to FIGS. 1 to 3 and 10B, the core 111 receives a process exit request in operation S710. For example, the core 111 may receive an exit request for the process “aaa.exe”.

In operation S720, the core 111 updates a process record of the process manager 115 without releasing the memory area allocated to the exit requested process. For example, the core 111 may move a record of the exit requested process from the run process table to the exit process table. Exemplarily, the core 111 may directly access and update the run process table managed by the process manager 115. The core 111 may update the process tables by sending an update request to the process manager 115. The core 111 may release control of the exit requested process before or after execution of operation S720.

FIG. 10C illustrates an example in which a frozen process is activated. It is assumed that the operation of FIG. 10C is performed after the operation of FIG. 10B is ended. Referring to FIGS. 1 to 3 and 10C, the core 111 receives a process run request in operation S810. For example, the core 111 may receive a run request for the process “aaa.exe”.

In operation S820, the core 111 performs a cache check. Operation S820 may be performed substantially the same as operation S620 discussed above with reference to in FIG. 10A.

In operation S830, the run requested process is determined to be registered (e.g., exists) in the process manager 115. In operation S840, instead of requesting allocation of the main memory 120, the core 111 activates the memory area in which a frozen process corresponding to the run requested process is stored, according to an address registered in the process manager 115. For example, the core 111 may activate control of the frozen process.

In operation S850, the core 111 updates a process record of the process manager 115. For example, a process record registered in the exit process table may be moved to a run process record.

FIG. 10D illustrates an example in which a memory area corresponding to a frozen process is released. It is assumed that the operation of FIG. 10D is performed after the operation of FIG. 10C is ended. Referring to FIGS. 1 to 3 and 10D, the core 111 receives a process run request in operation S910. For example, the core 111 may receive a run request for process “bbb.exe”.

In operation S920, the core 111 performs a cache check. Operation S920 may be performed substantially the same as operation S620 discussed above with reference to in FIG. 10A.

In operation S930, it is determined that the process corresponding to the process run request is not registered (e.g., does not exist) in the process manager 115.

In operation S940, the core 111 sends a memory release request to the memory management unit 113. For example, the core 111 may request a release of a memory area corresponding to a process having the lowest priority from among the processes registered in the exit process table.

In operation S950, the memory management unit 113 releases the requested memory area and then sends a memory release response to the core 111. In operation S960, the core 111 may send a memory allocation request to the memory management unit 113.

In operation S960, the memory management unit 113 may perform memory allocation and then send a memory allocation response to the core 111.

In operation S970, the core 111 updates a process record of the process manager 115. For example, a record of a frozen process corresponding to the released memory area may be deleted from the exit process table. A record of a process corresponding to the allocated memory area may be added to the run process table.

In operation S980, the core 111 loads the run requested process into the allocated memory area of the main memory 120.

As described with reference to FIGS. 10A to 10D, the process manager 115 may be accessed by the core 111. The core 111 may perform process freeze, activation, and release operations using process tables of the process manager 115.

Exemplarily, process freeze, activation, and release operations may be performed by separately specialized logic, not the core 111 or the memory management unit 113.

As described above, a newly run process may be loaded into the main memory 120. An exited process may be frozen. For example, the exited process may be managed using exit process table, not deleted from the main memory 120. If a run request for a frozen process is generated, the frozen process may be activated, instead of again loading the process. If the main memory 120 does not have enough storage capacity, a process having the lowest priority from among the frozen processes may be released.

In conventional computing systems using volatile memory, an exited process is instantly deleted from the main memory. Thus, a computing system and data management method according to embodiments of the inventive concept provide improved operating speed and user convenience, as compared with the conventional computing systems.

Exemplarily, a frozen process, a run process table and an exit process table may be retained without deletion even at power-on or power-off of the computing system 100. Thus, the computing system 100 retains contents worked by a user regardless of power-on or power-off of the computing system 100.

FIG. 2, in particular, illustrates an example in which a processor includes a memory management unit 113. However, the processor and the memory management unit 113 may be formed of separate semiconductor chips, respectively, without departing from the scope of the present teachings. In this case, the flow charts described in FIGS. 9A to 9D and FIGS. 10A to 10D, for example, may be substantially the same as applied where the core is replaced with a processor.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A method of managing data of a computing system, which uses a nonvolatile memory as a main memory, the method comprising:
loading a process into the nonvolatile memory in response to a first run request;
freezing the process loaded into the nonvolatile memory in response to an exit request of the process; and
activating the process frozen in the nonvolatile memory in response to a second run request of the process,
wherein freezing the process releases control of the process without deleting the process loaded into the nonvolatile memory.

2. The method of claim 1, wherein freezing the process retains a memory area of the nonvolatile memory corresponding to the process without releasing.

3. The method of claim 1, further comprising:
adding an address allocated to the process to a run process table in response to the first run request.

4. The method of claim 3, further comprising:
moving the address of the process registered in the run process table to an exit process table in response to the exit request.

5. The method of claim 4, wherein moving the address comprises:
selecting a priority of the process referring to a priority table; and
moving the address of the process to the exit process table according to the selected priority.

6. The method of claim 5, wherein the priority is selected according to information on a time when the process is most recently used or a run frequency of the process.

7. The method of claim 6, wherein the priority of the process increases in proportion to an increase in a run frequency of the process.

8. The method of claim 6, wherein the priority of the process increases in proportion to an increase in an exit time of the particular process.

9. The method of claim 6, wherein each of the run process table and the exit process table is configured to store a run frequency of each process.

10. The method of claim 5, wherein moving the address of the process to the exit process table according to the selected priority comprises:
comparing priorities of processes previously registered in the exit process table with the selected priority.

11. The method of claim 4, wherein when a release request is generated, memory areas of processes registered in the exit process table are released in an order from a process having a lower priority to a process having a higher priority.

12. The method of claim 11, wherein an address of a process corresponding to a released memory area is removed from the exit process table.

13. The method of claim 1, further comprising:
releasing a memory area corresponding to a process frozen in the nonvolatile memory when free space of the nonvolatile memory is not sufficient for loading the process.

14. The method of claim 1, wherein memory areas corresponding to processes loaded into the nonvolatile memory or frozen processes are not released even at power-on or power-off.

15. A computing system, comprising:
a nonvolatile storage;
a nonvolatile main memory; and
a processor configured to load a process into the nonvolatile main memory from the nonvolatile storage in response to a first run request, to freeze the process loaded into the nonvolatile main memory in response to an exit request of the process, and to activate the process frozen in the nonvolatile main memory in response to a second run request of the process,
wherein the freezing releases control of the process without deleting of the process loaded into the nonvolatile main memory; and
wherein the processor is further configured to skip an operation of loading the process into the nonvolatile main memory from the nonvolatile storage in response to the second run request.

16. The computing system of claim 15, wherein the processor comprises a process manager having a run process table for storing information on the process in response to the first run request and an exit process table for storing information on the process transferred from the run process table in response to the exit request.

17. The computing system of claim 16, wherein the run process table further stores information on the process transferred from the exit process table in response to the second run request.

18. A processor in a computing system including a main memory, the processor comprising:
a core configured to control processes of the computing system;
a main memory unit configured to manage the main memory under control of the core; and
a process manager configured to manage information on processes run and exited by the core, the process manager comprising a run process table for storing information on processes in response to run requests and an exit process table for storing information on processes transferred from the run process table in response to exit requests, the process manager determining whether a process of a run request, received by the core, is cached using the exit process table,
wherein, when the process manager determines that the process is cached, one of the core and the main memory unit activates a memory area in which the process is stored, and moves information regarding the process from the exit process table to the run process table of the process manager.

19. The process of claim 18, wherein, when the process manager determines that the process is not cached, one of the core and the main memory unit allocates a memory area of the main memory for the process, and adds information regarding the process to the run process table of the process manager.

20. The process of claim 19, wherein the information regarding the process added to the run process table comprises process name and process address, and the information regarding the process included in the exit process table comprises process name, process address and priority in relation to at least one other process.
